(19) United States
(12) Patent Application Publication
(10) Pub. No.: US 2020/0170059 A1
(43) Pub. Date: May 28, 2020

(54) CAPABILITY SIGNALLING FOR MULTICARRIER SIDELINK

(71) Applicant: TELEFONAKTIEBOLAGET LM ERICSSON (PUBL), Stockholm (SE)

(72) Inventors: Marco Belleschi, Solna (SE); Tao Cui, UPPLANDS VÄSBY (SE)

(21) Appl. No.: 16/090,448

(22) PCT Filed: Mar. 31, 2017
(86) PCT No.: PCT/IB2017/051869

§ 371 Date: Oct. 1, 2018

Related U.S. Application Data
(60) Provisional application No. 62/316,809, filed on Apr. 1, 2016.

(51) Int. Cl. H04W 76/15; H04W 4/40; H04W 16/14; H04W 8/22; H04W 76/14

(52) U.S. Cl. CPC H04W 76/15; H04W 4/40; H04W 76/14; H04W 8/22; H04W 16/14

(57) ABSTRACT

According to some embodiments, a method of signalling capability information for use in a wireless device comprises obtaining capability information about a capability of the wireless device for performing simultaneous sidelink communication over multiple carriers of a radio band, and communicating the capability information to a network element. The capability information comprises a capability of the wireless device for simultaneously transmitting and/or receiving sidelink communication over multiple carriers of the radio band and/or a capability of the wireless device for simultaneously performing sidelink communication and non-sidelink communication over multiple carriers of the radio band. According to some embodiments, a method of scheduling communication for use in a network node comprises receiving capability information about a capability of a wireless device for performing simultaneous sidelink communication over multiple carriers of a radio band, and scheduling a sidelink communication over one or more of the multiple carriers of the radio band.

### TECHNICAL FIELD

Particular embodiments are directed to wireless communications and, more particularly, to signalling capability information of a wireless device for multicarrier sidelink operation.

### INTRODUCTION

Third Generation Partnership Project (3GPP) long term evolution (LTE) Release 12 supports device to device (D2D) (also referred to as “sidelink”) features targeting both commercial and public safety applications. Some applications include device discovery, where devices establish a connection with another device in the proximity by broadcasting and detecting discovery messages that carry device and application identities. Another application includes direct communication based on physical channels terminated directly between devices. In 3GPP, these applications are defined under the umbrella of Proximity Services (ProSe).

One extension of the ProSe framework includes V2X communication, which includes any combination of direct communication between vehicles, pedestrians and infrastructure. V2X communication may take advantage of a network infrastructure, when available, but basic V2X connectivity may be possible even in case of lack of coverage. Providing an LTE-based V2X interface may be economically advantageous because of the LTE economies of scale. The LTE-based V2X interface may facilitate tighter integration between communications with the network infrastructure (V2I), pedestrians (V2P), and other vehicles (V2V) communications, as compared to using a dedicated V2X technology. Ongoing research projects and field tests of connected vehicles are occurring in various countries or regions, includes projects based on existing cellular infrastructure.

V2X communications may carry both safety and non-safety information. Each of the applications and services may be associated with specific requirements sets (e.g., in terms of latency, reliability, capacity, etc.). From the application point of view, V2X includes the following types of communication/services V2V, V2I, V2P and V2N. An example is illustrated in FIG. 1.

FIG. 1 illustrates various types of V2X communication. For example, FIG. 1 illustrates communication between a vehicle and a network (V2N), a vehicle and a person (V2P) such as a pedestrian, a vehicle and infrastructure (V2I) such as the illustrated traffic signal, and a vehicle to another vehicle (V2V).

V2V (vehicle to vehicle) refers to communication between vehicles using V2V applications and is predominantly broadcast-based. V2V may be realized by either direct communication between the devices in the respective vehicles, or via infrastructure such as a cellular network.

An example of V2V is the transmission of a cooperative awareness message (CAM) with vehicle status information (such as position, direction and speed) transmitted to other vehicles in the proximity repeatedly (every 100 ms-1 s). Another example is the transmission of a decentralized environmental notification message (DENM), which is an event-triggered message to alert vehicles. These two examples are taken from the ETSI Intelligent Transport Systems (ITS) specification of V2X applications, which also specifies the conditions under which the messages are generated. One characteristic of V2V applications is the tight requirements on latency that can vary from 20 ms (for pre-crash warning messages) to 100 ms for other road safety services.

V2I (vehicle to infrastructure) refers to communication between vehicles and a Roadside Unit (RSU). The RSU is a stationary transportation infrastructure entity which communicates with vehicles in its proximity. An example of V2I is transmission of speed notifications from the RSU to vehicles, as well as queue information, collision risk alerts, curve speed warnings. Because of the safety related nature of V2I, delay requirements are similar to V2V requirements.

V2P (vehicle to pedestrian) refers to communication between vehicles and vulnerable road users, such as pedestrians, using V2P applications. V2P typically takes place between distinct vehicles and pedestrians either directly or via infrastructure such as cellular network. V2N (vehicle to network) refers to communication between a vehicle and a centralized application server (or an ITS Traffic Management Center) both using V2N applications, via infrastructure (such as a cellular network). Examples include a bad road condition warning sent to all vehicles in a wide area, or traffic flow optimization in which V2N application suggests speeds to vehicles and coordinates traffic lights.

Therefore, V2N messages are usually controlled by a centralized entity (i.e., the Traffic Management Center) and provisioned to vehicles in a large geographical area, rather than in a small area. Additionally, unlike V2V/V2I, latency requirements are more relaxed in V2N because it is not meant to be used for non-safety purposes (e.g., a 1 s latency requirement may be typical).

The development of V2X standards, including the application layer, has been based on IEEE 802.11p dedicated short-range communication (DSRC), such as in the ETSI Intelligent Transport Systems (ITS G5) and IEEE WAVE (Wireless Access in Vehicular Environments) families of specifications. These technologies are designed to operate in the 5.9 Ghz band.

The DSRC-based V2X communication inherently provides a short range (such as 250-500 m). Providing a wide area coverage relies on the deployment of Road-Side Units (RSUs), which may be used as a relay. Moreover, by connecting the DSRC-based RSU to a Traffic Management Center, V2N applications may be used over DSRC, as depicted in FIG. 2.

FIG. 2 illustrates DSRC-based V2X communication using road-side units (RSU). Traffic management center 8 may communicate with vehicles 10 over network 12. Road-side units 14 may relay communications from traffic management center 8 to vehicles 10 or between two or more vehicles 10. For example, traffic management center 8 may inform vehicle 10 of a crash between two other vehicles 10.

Besides providing pure relaying functionality, the RSU is also typically involved in Vehicle-to-Infrastructure (V2I) communication. Some of the use cases where the RSU is involved are, for example, V2I Emergency Stop, Queue Warning, Automated Parking System, and V2X road safety service via infrastructure.

Some V2X implementations use LTE. Because of the range limitations of DSRC and to avoid deploying a new and separate technology and/or wireless infrastructure only for V2X, reusing the cellular network for V2X communication is beneficial.

V2V communication relying exclusively on cellular network infrastructure, however, may not alone support all types of vehicular applications. For example, cellular infrastructure may not support applications involving rapid exchanges of information between a large numbers of cars in proximity. Thus, a direct wireless communication may still be used as a complement.

3GPP is investigating the use of the Evolved Packet System (EPS), including LTE as a wireless technology, for V2X services, with the intention that Release 14 will include the support for V2X, as described in 3GPP TR 22.885 V14.0.0 (2015 December), Study on LTE support for Vehicle to Everything (V2X) services. Proximity-based Services (ProSe) (i.e., Device-to-Device communications, D2D) introduced in 3GPP Release 12 provides the basic functionality to support direct communication for V2X services over the sidelink (i.e., the direct link between UEs introduced in 3GPP Release 12). Furthermore, LTE-based broadcast services, such as eMBMS, could provide additional functionalities for V2X services. An example is illustrated in FIG. 3.

FIG. 3 illustrates examples of using LTE for V2X communication. Particular examples may include a mix of sidelink (D2D/PC5) and uplink/downlink. A vehicle in the V2X context will include a (vehicle) UE, which in turn provides a Uu interface as well as a PC5 interface which corresponds to the sidelink interface. Moreover, both UE-based RSUs (providing PC5 connectivity with vehicle UEs) as well as eNB-based RSUs (providing only Uu connectivity with vehicle UEs) are two alternative realizations of the RSU.

Multicarrier operation may be beneficial for some D2D scenarios. For example, in V2X road safety use cases, receiving a particular message with sufficient reliability may be important. A transmitting V2X device can, for example, replicate a certain message on multiple carriers. One goal of ITS safety services is to reduce the number of traffic fatalities or accidents. This poses stringent requirements on communication reliability and interference environment in ITS safety channels. Another benefit is the possibility to increase the data rate of the sidelink, thereby opening D2D to a wider set of applications which demand higher data rate, for example infotainment services, autonomous driving, etc.

Additionally, V2X may operate at 5.9 Ghz where other ITS technologies, such as DSRC, are also operating. One possible transceiver configuration for a UE may support simultaneous transmission/reception at 5.9 Ghz in the ITS bands and in the LTE bands where coexistence with legacy Uu operation is a requirement.

UE capabilities for ProSe operations are specified in 3GPP Release 12. A UE signals its transceiver capabilities by indicating to the eNB the band(s) in which ProSe operations are supported. Additionally, the UE indicates to the eNB for each band combination which are the ProSe bands in which simultaneous reception (and possibly transmission) of PC5 on one of the ProSe bands at a time and Uu is supported.

A problem with the current capabilities, however, is that the UE cannot indicate the ProSe bands in which simultaneous transmission/reception over multiple carriers on the ProSe bands are supported. Similarly, the UE cannot indicate if in the bands in which the UE supports simultaneous PC5 transmission/reception over multiple carriers, Uu operations are also supported. The problems are limiting because the eNB cannot properly perform multi-carrier scheduling.

### SUMMARY

The embodiments described herein facilitate a wireless device signalling its multicarrier device-to-device (D2D) communication capabilities to another network element, such as a network node or another wireless device. Particular embodiments may include any of the following: (a) signalling of bands (including unlicensed bands) in which simultaneous PC5 operations over multiple PC5 carriers is supported; (b) signalling of bands in which simultaneous PC5 operations over multiple PC5 carriers and Uu is supported; (c) signalling of unlicensed bands in which simultaneous PC5 operations over multiple PC5 carriers and Uu is supported; (d) signalling of bands (including unlicensed bands) in which simultaneous PC5 operations over multiple PC5 carriers is supported by configuration of PC5 gaps; and (e) signalling of bands (including unlicensed bands) in which simultaneous PC5 operations over multiple PC5 carriers and Uu is supported by configuration of PC5 gaps.

According to some embodiments, a method of signalling capability information for use in a wireless device comprises obtaining capability information about a capability of the wireless device for performing simultaneous sidelink communication over multiple carriers of a radio band, and communicating the capability information to a network element (e.g., network node or another wireless device). The capability information comprises a capability of the wireless device for simultaneously transmitting and/or receiving sidelink communication over multiple carriers of the radio band and/or a capability of the wireless device for simultaneously performing sidelink communication and non-sidelink communication over multiple carriers of the radio band.

In particular embodiments, the sidelink communication comprises PC5 communication and the non-sidelink communication comprises Uu communication. The capability information may comprise an indication of whether the wireless device uses sidelink gaps for multicarrier communication. The sidelink communication may comprise V2X communication. The radio band may comprise an unlicensed band.

According to some embodiments, a method of scheduling communication for use in a network node comprises receiving capability information about a capability of a wireless device for performing simultaneous sidelink communication over multiple carriers of a radio band, and scheduling a communication (e.g., sidelink and/or Uu) over one or more of the multiple carriers of the radio band. Scheduling the communication may comprise scheduling a traffic safety message over two or more of the multiple carriers. The capability information comprises a capability of the wireless device for simultaneously transmitting and/or receiving sidelink communication over multiple carriers of the radio band and/or a capability of the wireless device for simultaneously performing sidelink communication and non-sidelink communication over multiple carriers of the radio band.

In particular embodiments, the sidelink communication comprises PC5 communication and the non-sidelink communication comprises Uu communication. The capability information may comprise an indication of whether the wireless device uses sidelink gaps for multicarrier communication. The sidelink communication may comprise V2X communication. The radio band may comprise an unlicensed band.

According to some embodiments, a wireless device operable to signal capability information comprises processing circuitry and a transceiver. The processing circuitry is operable to obtain capability information about a capability of the wireless device for performing simultaneous sidelink communication over multiple carriers of a radio band. The transceiver is operable to communicate the capability information to a network element (e.g., network node, wireless device).

According to some embodiments, a network node operable to schedule communication comprises processing circuitry and a transceiver. The transceiver is operable to receive capability information about a capability of a wireless device for performing simultaneous sidelink communication over multiple carriers of a radio band. The processing circuitry is operable to schedule a communication (e.g., sidelink and/or Uu) over one or more of the multiple carriers of the radio band for one or more wireless devices.

According to some embodiments, a wireless device operable to signal capability information comprises a determining module and a communicating module. The determining module is operable to obtain capability information about a capability of the wireless device for performing simultaneous sidelink communication over multiple carriers of a radio band. The communicating module is operable to communicate the capability information to a network element (e.g., network node, wireless device).

According to some embodiments, a network node operable to schedule communication comprises a communicating module and a load-balancing module. The communicating module is operable to receive capability information about a capability of a wireless device for performing simultaneous sidelink communication over multiple carriers of a radio band. The load-balancing module is operable to schedule a communication (e.g., sidelink and/or Uu) over one or more of the multiple carriers of the radio band for one or more wireless devices.

Also disclosed is a computer program product. The computer program product comprises instructions stored on non-transient computer-readable media which, when executed by a processor, perform the acts obtaining capability information about a capability of the wireless device for performing simultaneous sidelink communication over multiple carriers of a radio band, and communicating the capability information to a network element (e.g., network node or another wireless device).

Another computer program product comprises instructions stored on non-transient computer-readable media which, when executed by a processor, perform the acts of receiving capability information about a capability of a wireless device for performing simultaneous sidelink communication over multiple carriers of a radio band, and scheduling a communication (e.g., sidelink and/or Uu) over one or more of the multiple carriers of the radio band.

Particular embodiments may exhibit some of the following technical advantages. For example, if a network node, such as an eNB, knows which ProSe bands support simultaneous transmission/reception over multiple carriers, the network node may consider scheduling certain traffic safety message over multiple carriers to increase reliability. Additionally, with respect to ITS operating only in unlicensed spectrum, the network node needs to know whether the wireless device can support simultaneous Uu operations and ITS in unlicensed spectrum. At least on the basis of congestion status, it is desirable if a wireless device transmits a road safety message in one or more carriers to both limit the network load and increase the probability that a message is actually received by a wireless device in the proximity.

In general, embodiments of the present disclosure may provide one or more technical advantages. For example, the proposed solutions may enable a wireless device, such as a UE, to indicate to a network node, such as an eNB, its capability to support simultaneous PC5 operations (transmission and/or reception) over multiple carriers (including unlicensed carriers). Additionally, methods to indicate simultaneous PC5 operations over multiple carriers and Uu are disclosed. A network node, such as an eNB, can use such information to properly balance the load over the multiple available PC5 carriers. Additionally, the eNB by knowing UE capabilities can aid UEs in the proximity detection of each other. Other technical advantages will be readily apparent to one skilled in the art from the following figures, description and claims.

### BRIEF DESCRIPTION OF THE DRAWINGS

For a more complete understanding of the embodiments and their features and advantages, reference is now made to the following description, taken in conjunction with the accompanying drawings, in which:

FIG. 1 illustrates various types of V2X communication;

FIG. 2 illustrates DSRC-based V2X communication using road-side units (RSU);

FIG. 3 illustrates examples of using LTE for V2X communication;

FIG. 4 is a block diagram illustrating an example wireless network, according to some embodiments;

FIG. 5 is a flow diagram illustrating an example method in a wireless device, according to some embodiments;

FIG. 6 is a flow diagram illustrating an example method in a network node, according to some embodiments;

FIG. 7A is a block diagram illustrating an example embodiment of a wireless device;

FIG. 7B is a block diagram illustrating example components of a wireless device;

FIG. 7A is a block diagram illustrating an example embodiment of a network node; and

FIG. 8B is a block diagram illustrating example components of a network node.

### DETAILED DESCRIPTION

Third Generation Partnership Project (3GPP) long term evolution (LTE) Release 12 supports device to device (D2D) (also referred to as “sidelink”) features targeting both commercial and public safety applications. Some applications include device discovery, where devices establish a connection with another device in the proximity by broadcasting and detecting discovery messages that carry device and application identities. Another application includes direct communication based on physical channels terminated directly between devices. In 3GPP, these applications are defined under the umbrella of Proximity Services (ProSe).

One extension of the ProSe framework includes V2X communication, which includes any combination of direct communication between vehicles, pedestrians and infrastructure. V2X communication may take advantage of a network infrastructure, when available, but basic V2X connectivity may be possible even in case of lack of coverage.

The development of V2X standards, including the application layer, has been based on IEEE 802.11p dedicated short-range communication (DSRC), such as in the ETSI Intelligent Transport Systems (ITS G5) and IEEE WAVE (Wireless Access in Vehicular Environments) families of specifications. These technologies are designed to operate in the 5.9 GHz band.

3GPP is investigating the use of the Evolved Packet System (EPS), including LTE as a wireless technology, for V2X services, with the intention that Release 14 will include the support for V2X, as described in 3GPP TR 22.885 V14.0.0 (2015 December), Study on LTE support for Vehicle to Everything (V2X) services. Proximity-based Services (ProSe) (i.e., Device-to-Device communications, D2D) introduced in 3GPP Release 12 provides the basic functionality to support direct communication for V2X services over the sidelink (i.e., the direct link between UEs introduced in 3GPP Release 12). Furthermore, LTE-based broadcast services, such as eMBMS, could provide additional functionalities for V2X services.

Multicarrier operation may be beneficial for some D2D scenarios. For example, in V2X road safety use cases, receiving a particular message with sufficient reliability may be important. A transmitting V2X network node can, for example, replicate a certain message on multiple carriers. One goal of ITS safety services is to reduce the number of traffic fatalities or accidents. This poses stringent requirements on communication reliability and interference environment in ITS safety channels. Another benefit is the possibility to increase the data rate of the sidelink, thereby opening D2D to a wider set of applications which demand higher data rate, for example infotainment services, autonomous driving, etc.

Additionally, V2X may operate at 5.9 GHz where other ITS technologies, such as DSRC, are also operating. One possible transceiver configuration for a UE may support simultaneous transmission/reception at 5.9 GHz in the ITS bands and in the LTE bands where coexistence with legacy Uu operation is a requirement.

UE capabilities for ProSe operations are specified in 3GPP Release 12. A UE signals its transceiver capabilities by indicating to the eNB the band(s) in which ProSe operations are supported. Additionally, the UE indicates to the eNB for each band combination which are the ProSe bands in which simultaneous reception (and possibly transmission) of PC5 on one of the ProSe bands at a time and Uu is supported.

A problem with the current capabilities, however, is that the UE cannot indicate which ProSe bands support simultaneous transmission/reception over multiple carriers on the ProSe bands. Similarly, the UE cannot indicate if in the bands in which the UE supports simultaneous PC5 transmission/reception over multiple carriers, Uu operations are also supported. The problems are limiting because the eNB cannot properly perform multi-carrier scheduling.

Particular embodiments obviate the problems described above and facilitate a wireless device signalling its multicarrier device-to-device (D2D) communication capabilities to another network element, such as a network node or another wireless device. Particular embodiments may include any of the following: (a) signalling of bands (including unlicensed bands) in which simultaneous PC5 operations over multiple PC5 carriers is supported; (b) signalling of bands in which simultaneous PC5 operations over multiple PC5 carriers and Uu is supported; (c) signalling of unlicensed bands in which simultaneous PC5 operations over multiple PC5 carriers and Uu is supported; (d) signalling of bands (including unlicensed bands) in which simultaneous PC5 operations over multiple PC5 carriers is supported by configuration of PC5 gaps; and (e) signalling of bands (including unlicensed bands) in which simultaneous PC5 operations over multiple PC5 carriers and Uu is supported by configuration of PC5 gaps.

If an eNB knows which ProSe bands support simultaneous transmission/reception over multiple carriers, the eNB may consider scheduling certain traffic safety message over multiple carriers to increase reliability. Additionally, with respect to ITS operating only in unlicensed spectrum, the eNB needs to know whether the UE can support simultaneous Uu operations and ITS in unlicensed spectrum. At least on the basis of congestion status, it is desirable if a UE transmits a road safety message in one or more carriers to both limit the network load and increase the probability that a message is actually received by a UE in the proximity.

The following description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

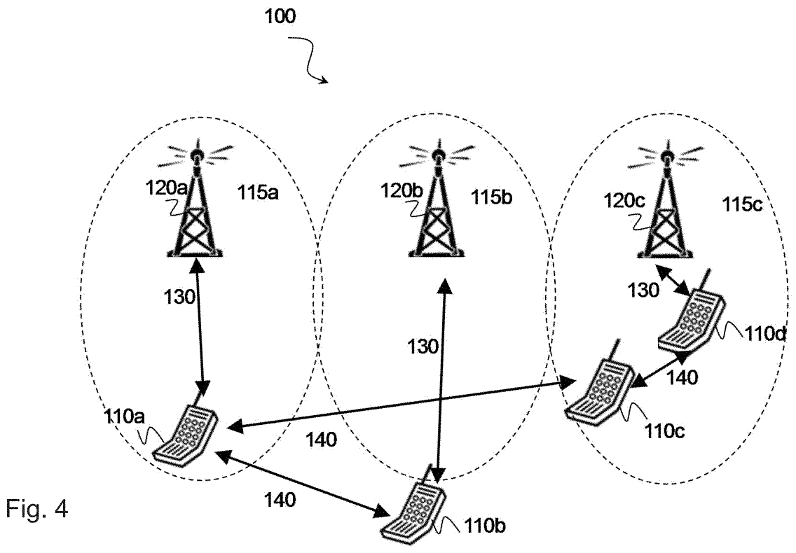

Particular embodiments are described with reference to FIGS. 4-8B of the drawings, like numerals being used for like and corresponding parts of the various drawings. LTE is used throughout this disclosure as an example cellular system, but the ideas presented herein may apply to other wireless communication systems as well.

FIG. 4 is a block diagram illustrating an example wireless network, according to a particular embodiment. Wireless network 100 includes one or more wireless devices 110 (such as mobile phones, smart phones, laptop computers, tablet computers, MTC devices, or any other devices that can provide wireless communication) and a plurality of network nodes 120 (such as base stations or eNodeBs). Wireless device 110 may also be referred to as a UE. Network node 120 serves coverage area 115 (also referred to as cell 115).

In general, wireless devices 110 that are within coverage of network node 120 (e.g., within cell 115 served by network node 120) communicate with network node 120 by transmitting and receiving wireless signals 130. For example, wireless devices 110 and network node 120 may communicate wireless signals 130 containing voice traffic, data traffic, and/or control signals.

A network node 120 communicating voice traffic, data traffic, and/or control signals to wireless device 110 may be referred to as a serving network node 120 for the wireless device 110. Communication between wireless device 110 and network node 120 may be referred to as cellular communication. Wireless signals 130 may include both downlink transmissions (from network node 120 to wireless devices 110) and uplink transmissions (from wireless devices 110 to network node 120). In LTE, the interface for communicating wireless signals between network node 120 and wireless device 110 may be referred to as a Uu interface.

Each network node 120 may have a single transmitter or multiple transmitters for transmitting signals 130 to wireless devices 110. In some embodiments, network node 120 may comprise a multi-input multi-output (MIMO) system. Similarly, each wireless device 110 may have a single receiver or multiple receivers for receiving signals 130 from network nodes 120 or other wireless devices 110.

Wireless devices 110 may communicate with each other (i.e., D2D operation) by transmitting and receiving wireless signals 140. For example, wireless device 110a may communicate with wireless device 110b using wireless signal 140. Wireless signal 140 may also be referred to as sidelink 140. Communication between two wireless devices 110 may be referred to as D2D communication or sidelink communication. In LTE, the interface for communicating wireless signal 140 between wireless device 110 may be referred to as a PC5 interface.

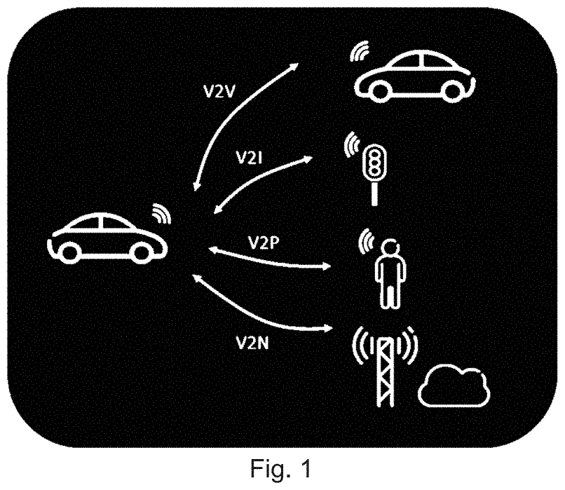

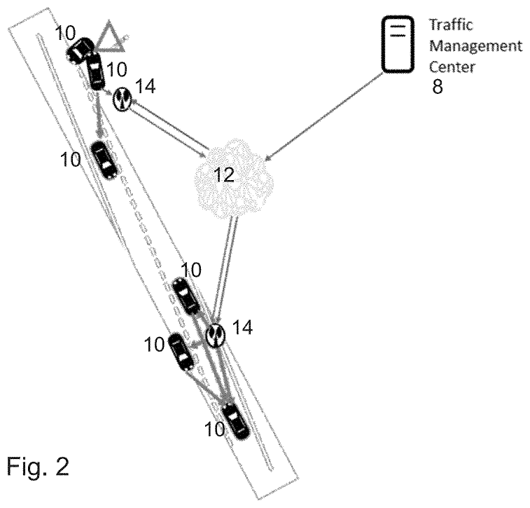

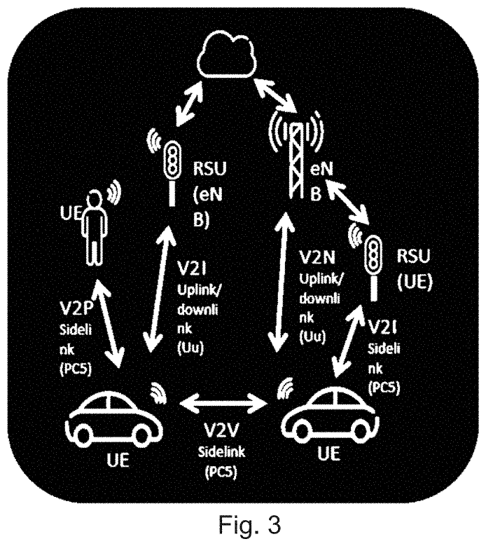

In particular embodiments, wireless signal 140 may use a different carrier frequency than the carrier frequency of wireless signal 130. For example, wireless device 110a may communicate with network node 120a using a first frequency band and may communicate with wireless device 110b using the same frequency band or a second frequency band. Wireless devices 110a and 110b may be served by the same network node 120 or by different network nodes 120. In particular embodiments, one or both of network nodes 110a and 110b may be out-of-coverage of any network node 120. Wireless signal 140 may include any of the V2X communications described with respect to FIGS. 1-3.

In particular embodiments, wireless device 110 obtains capability information about a capability of wireless device 110 for performing simultaneous sidelink communication over multiple carriers of a radio band. Wireless device may communicate the capability information to network node 120 or another wireless device 110.

Network node 120 receives capability information about a capability of wireless device 110 for performing simultaneous sidelink communication over multiple carriers of a radio band. Network node 120 may schedule a communication (e.g., sidelink and/or Uu) over one or more of the multiple carriers of the radio band. Scheduling the communication may comprise scheduling a traffic safety message over two or more of the multiple carriers. The capability information comprises a capability of the wireless device for simultaneously transmitting and/or receiving sidelink communication over multiple carriers of the radio band and/or a capability of the wireless device for simultaneously performing sidelink communication and non-sidelink communication over multiple carriers of the radio band.

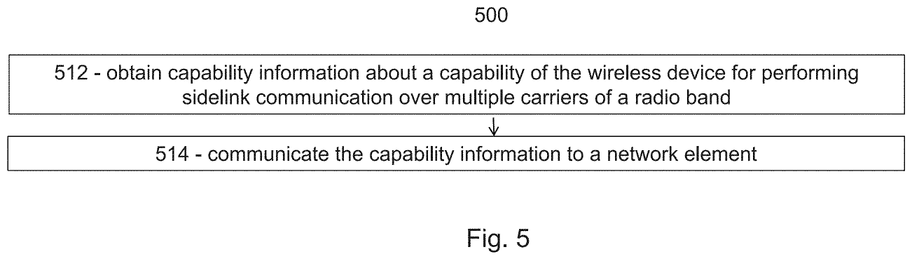

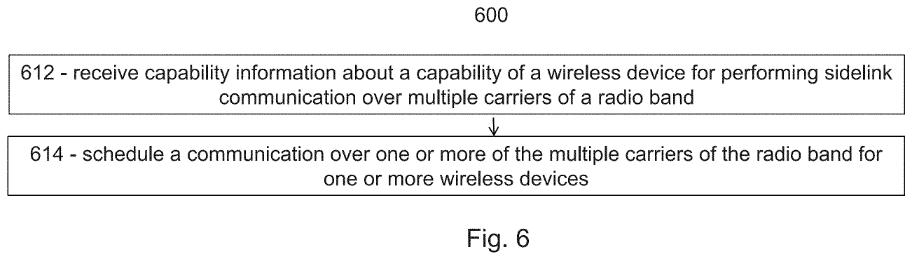

In particular embodiments, the sidelink communication comprises PC5 communication and the non-sidelink communication comprises Uu communication. The capability information may comprise an indication of whether the wireless device uses sidelink gaps for multicarrier communication. The sidelink communication may comprise V2X communication. The radio band may comprise an unlicensed band. Particular algorithms for signalling multi-frequency capabilities are described in more detail with respect to FIGS. 5 and 6 and the examples described below.

In wireless network 100, each network node 120 may use any suitable radio access technology, such as long term evolution (LTE), 5G NR, LTE-Advanced, UMTS, HSPA, GSM, cdma2000, NR, WiMax, WiFi, and/or other suitable radio access technology. Wireless network 100 may include any suitable combination of one or more radio access technologies. For purposes of example, various embodiments may be described within the context of certain radio access technologies. However, the scope of the disclosure is not limited to the examples and other embodiments could use different radio access technologies.

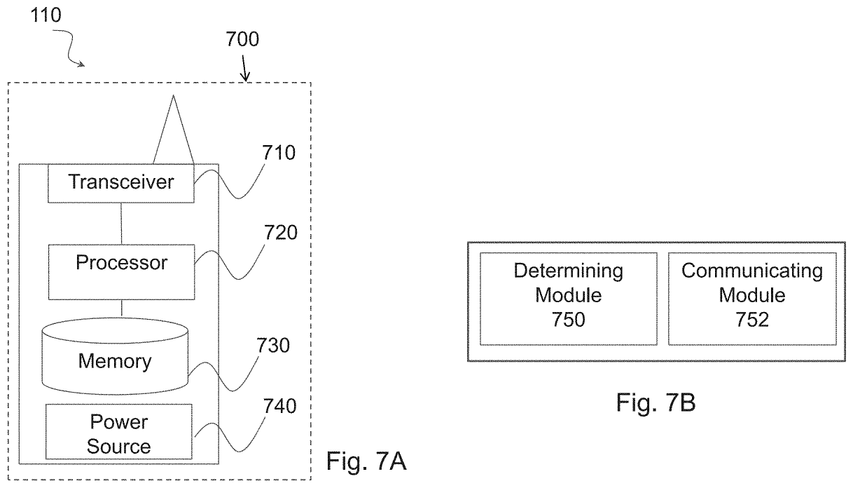

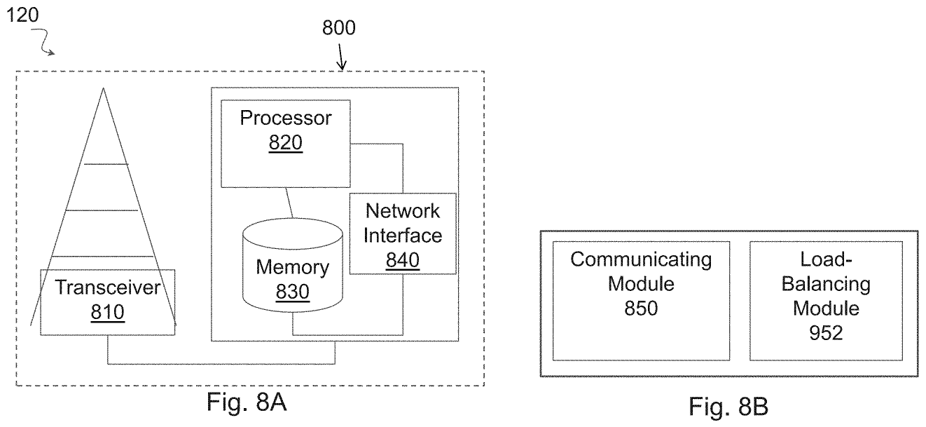

As described above, embodiments of a wireless network may include one or more wireless devices and one or more different types of radio network nodes capable of communicating with the wireless devices. The network may also include any additional elements suitable to support communication between wireless devices or between a wireless device and another communication device (such as a landline telephone). A wireless device may include any suitable combination of hardware and/or software. For example, in particular embodiments, a wireless device, such as wireless device 110, may include the components described with respect to FIG. 7A below. Similarly, a network node may include any suitable combination of hardware and/or software. For example, in particular embodiments, a network node, such as network node 120, may include the components described with respect to FIG. 8A below.

In general, particular embodiments include simultaneous ProSe transmission/reception on sidelink carriers. A wireless device may indicate for each band in which it supports sidelink operations whether it supports simultaneous sidelink reception and/or transmission on any of the other bands in which sidelink operation is supported. In some embodiments, the capability information may be represented by a bitmap for each of the supported bands.

For example, if sidelink is supported on band X, Y, Z, the capability signalling consists of a bitmap indicating for each supported band whether simultaneous sidelink reception and/or transmission is supported in any of the other supported bands. Value 1, for example, indicates support. The value corresponding to support of a certain band in the same band indicates support for intra-band simultaneous reception and/or transmission in that band.

TABLE 1
Indicating simultaneous sidelink operations (transmission
and/or reception) in multiple sidelink carriers.

| Supported bands | X | Y | Z |
|---|---|---|---|
| X | 1 | 0 | 0 |
| Y | 0 | 1 | 1 |
| Z | 0 | 1 | 1 |

In particular embodiments, the wireless device may not indicate the above for each sidelink supported band if it can indicate simultaneous sidelink support of that band in another band.

In 3GPP TS 36.331, the embodiment can be represented by the following where the supported band info list may or may not include E-UTRA bands:

| | |
|---|---|
| SL-Parameters-r14 ::= | SEQUENCE { |

| | |
|---|---|
| SidelinkSupportedBands-r14 | SupportedBandInfoList- |

r14
}

| | |
|---|---|
| SupportedBandInfoList-r14 ::= | SEQUENCE (SIZE (1..maxBands)) |

OF SupportedBandInfo-r14

| SupportedBandInfo-r14 ::= | | SEQUENCE { |
|---|---|---|
| | supportedBandInfo-r13 | SupportedBandInfo-r13 OPTIONAL |

| | |
|---|---|
| simultaneousSupportedBands-r14 | BIT STRING (SIZE (1.. |

maxBands)) OPTIONAL
}

In particular embodiments, the wireless device signals all the sidelink band combinations in which simultaneous sidelink reception and/or transmission over multiple carriers is supported. IF the wireless device supports multiple carriers sidelink on one band (intra band), a one-bit indication is signaled for the band. For inter band multi-carrier sidelink, the wireless device may signal all the combinations it supports.

In 3GPP TS 36.331, the embodiment can be represented by the following where the supported ProSe bands may or may not include E-UTRA bands or unlicensed bands:

| | |
|---|---|
| SL-Parameters-v14xy ::= | SEQUENCE { |

commMultiCarrierSupportedIntraBand-r14
CommMultiCarrierSupportedIntraBand-r14 OPTIONAL,
commMultiCarrierSupportedInterBand-r14
CommMultiCarrierSupportedInterBand-r14 OPTIONAL

}
-- length of the below bit string is the number of supported
Prose bands for sidelink communication the UE reports as in
rel-12. The order from leftmost bit in the bit string also
follows the same order as listed in the supported Prose bands
for sidelink communication (i.e. commSupportedBands). Each bit
of value 1 or 0 indicates whether multi-carrier sidelink
communication within the band is supported.
CommMultiCarrierSupportedIntraBand-r14 ::= BIT STRING (SIZE
(1..maxBands))
--each supported sidelink band combination is a bit string
ordered as listed in the supported Prose bands for sidelink
communication (i.e. commSupportedBands). It indicates multi-
carrier simultaneous reception supported over the
corresponding bands.
CommMultiCarrierSupportedInterBand-r14 ::= SEQUENCE (SIZE
(1..maxSL-BandCombination-r14)) OF SupportedSL-
BandCombinations-r14
SupportedSL-BandCombinations-r14 ::= BIT STRING (SIZE
(1..maxBands))

In case the above specification only applies to sidelink reception (transmission) the sidelink transmission (reception) capability is indicated by the wireless device which may signal with a bit that in those bands also simultaneous sidelink transmission (reception) is possible. If simultaneous transmission (reception) is possible in different bands than those in which simultaneous reception (transmission) is possible, the wireless device can report a separate list of bands in which simultaneous sidelink transmission (reception) is possible.

Some embodiments include simultaneous ProSe transmission/reception on sidelink carriers and Uu. Particular embodiments signal support of simultaneous transmission/reception over sidelink and Uu. Even though a wireless device may support simultaneous sidelink operations over multiple sidelink carriers, the wireless device may support simultaneous sidelink and Uu operations only in a subset of the sidelink carriers in which simultaneous sidelink operations are supported.

Therefore, in particular embodiments the wireless indicates whether simultaneous sidelink transmission and/or reception and Uu is possible for each band combination and for each combination of bands in which simultaneous sidelink is possible, or for each band in which sidelink transmission and/or reception is possible.

Table 2 indicates support for the different supported band combinations. For example, for the band combination A_A, the wireless device may signal the following to indicate that it support simultaneous Uu and sidelink transmission and/or reception only in a subset of the sidelink carriers in which multicarrier sidelink is supported, i.e. Uu on band A_A and sidelink carriers on X is supported separately, but not simultaneously on both carriers Y and Z. In particular embodiments, X may represent either a ProSe band combination (i.e., a group of ProSe bands where simultaneous sidelink reception/transmission is supported) or a single sidelink band where sidelink transmission/reception is supported.

TABLE 2
Indicating simultaneous sidelink transmission
and or reception and Uu operations in multiple sidelink carriers.

| Band | | | |
|---|---|---|---|
| Combinations | X | Y | Z |
| A_A | 1 | 0 | 0 |
| A_B | 1 | 1 | 0 |
| A_C | 0 | 0 | 1 |

The signalling may include the following. Each bit string below indicates which intra band and inter band combinations multi-carrier sidelink reception/transmission together with Uu are supported. This is a subset of combinations the wireless device has indicated its support for intra/inter ProSe bands multi-carrier simultaneous sidelink. If the UE supports simultaneous Uu and sidelink in the same set (i.e., not subset) of ProSe band combinations for one band combination, the wireless device may indicate this with a one-bit indicator. Otherwise for each ProSe band combination in which simultaneous sidelink transmission and/or reception is supported and for each band combination, the wireless device may indicate with a bit whether simultaneous sidelink and Uu is supported.

--length of bit string should be the sum of all intra and
inter band combinations the UE supports as indicated in
Embodiment 1.
BandCombinationParameters-v14xy::= SEQUENCE {

commMultiCarrierSupportedPerBC-r14 CHOICE {

| | |
|---|---|
| sameCombinationSetSupported-r14, | ENUMERATED {true} |
| subCombinationSetsupported-r14 | BIT STRING (SIZE |

(1..maxSL-BandCombination-r14))

| | |
|---|---|
| } | OPTIONAL |

}

In particular embodiments, the wireless device signals with a bit string for all the sidelink bands in which sidelink is supported and for each band combination, whether simultaneous sidelink transmission and/or reception and Uu is supported.

In case, the above specification only applies to sidelink reception (transmission) the simultaneous sidelink transmission (reception) and Uu capability is indicated by the wireless device which may signal with a bit that in those bands also simultaneous sidelink transmission (reception) and Uu is possible. If simultaneous transmission (reception) and Uu is possible in different bands than those in which simultaneous reception (transmission) and Uu is possible, the wireless device can report a separate list of bands in which simultaneous transmission (reception) and Uu is possible.

Particular embodiments may include an indication of a sidelink gap. According to particular embodiments, sidelink operations across bands are supported but gaps need to be configured. Sidelink gaps may be needed to support operations between sidelink carriers and also between sidelink carriers and Uu.

Some embodiments may indicate whether sidelink gap is required as a Boolean:

| | |
|---|---|
| SL-Parameters-r14 ::= | SEQUENCE { |

| | |
|---|---|
| SidelinkSupportedBands-r14 | SupportedBandInfoList- |

r14

| | |
|---|---|
| sidelinkGap | BOOLEAN |

}

If the sidelinkGap flag is true, the wireless device requires sidelink gap between all the supported carriers for which simultaneous sidelink transmission/reception is not possible. Support of simultaneous sidelink transmission/reception is determined according to the embodiments discussed above.

Similarly, sidelink gaps may be used between Uu operation and sidelink.

BandCombinationParametersCommon-r14 ::= SEQUENCE {

sidelinkSupportedBandsPerBC-r14 SEQUENCE (SIZE

| (1..maxSimultaneousSupportedBandPerBC)) OF | |
|---|---|
| SidelinkSupportedBandsPerBC-r14 | OPTIONAL |

| | |
|---|---|
| sidelinkGap | BOOLEAN |

}

If the sidelinkGap flag is true, the wireless device requires sidelink gap between any of the supported sidelink bands and the bands in the band combination for which simultaneous sidelink transmission/reception and Uu is not possible.

The examples described above may be generally represented by the flowcharts in FIG. 5 (with respect to a network node) and FIG. 6 (with respect to a network node).

FIG. 5 is a flow diagram illustrating an example method in a wireless device, according to some embodiments. In particular embodiments, one or more steps of FIG. 5 may be performed by wireless device 110 described with respect to FIG. 4.

The method begins at step 512, where the wireless device obtains capability information about its capability for performing sidelink communication over multiple carriers of a radio band. For example, wireless device may have been previously configured for operation over a particular combination of carriers. In some embodiments, the wireless device may perform measurements and tests to determine its capabilities. The wireless device may obtain its capability information according to any of the examples and embodiments described above.

For example, the capability information may comprise a capability of the wireless device for simultaneously transmitting and/or receiving sidelink communication over multiple carriers of the radio band and/or a capability of the wireless device for simultaneously performing sidelink communication and non-sidelink communication over multiple carriers of the radio band.

In particular embodiments, the sidelink communication comprises PC5 communication and the non-sidelink communication comprises Uu communication. The capability information may comprise an indication of whether the wireless device uses sidelink gaps for multicarrier communication. The sidelink communication may comprise V2X communication. The radio band may comprise an unlicensed band.

At step 514, the wireless device communicates the capability information to a network element. For example, wireless device 110 may communicate the capability information to network node 120, another wireless device 110, or any other suitable component of network 100.

Modifications, additions, or omissions may be made to method 500. Additionally, one or more steps in method 500 of FIG. 5 may be performed in parallel or in any suitable order. The steps of method 500 may be repeated over time as necessary.

FIG. 6 is a flow diagram illustrating an example method in a network node, according to some embodiments. In particular embodiments, one or more steps of FIG. 6 may be performed by network node 120 described with respect to FIG. 4.

The method begins at step 612, where the network node receives capability information about a capability of a wireless device for performing sidelink communication over multiple carriers of a radio band. For example, network node 120 may receive capability information about a capability of wireless device 110 for performing sidelink communication over multiple carriers of a radio band according to any of the examples and embodiments described above.

In some embodiments, network node 120 may obtain the capability information via signaling from wireless device 110, from another network node 120, or from any other suitable component of network 100.

For example, the capability information may comprise a capability of the wireless device for simultaneously transmitting and/or receiving sidelink communication over multiple carriers of the radio band and/or a capability of the wireless device for simultaneously performing sidelink communication and non-sidelink communication over multiple carriers of the radio band.

In particular embodiments, the sidelink communication comprises PC5 communication and the non-sidelink communication comprises Uu communication. The capability information may comprise an indication of whether the wireless device uses sidelink gaps for multicarrier communication. The sidelink communication may comprise V2X communication. The radio band may comprise an unlicensed band.

At step 614, the network node schedules a sidelink communication over one or more of the multiple carriers of the radio band for one or more wireless devices. For example, network node 120 may schedule a sidelink communication over one or more of the multiple carriers of the radio band for wireless device 110 according to any of the embodiments and examples described above. For example, scheduling the sidelink communication may comprise scheduling a traffic safety message over two or more of the multiple carriers.

In particular embodiments the network node may use the capability information to balance the load over the multiple available PC5 carriers. The network node, by knowing the wireless device capabilities, can aid wireless devices in proximity detection of each other.

Modifications, additions, or omissions may be made to method 600. Additionally, one or more steps in method 600 of FIG. 6 may be performed in parallel or in any suitable order. The steps of method 600 may be repeated over time as necessary.

FIG. 7A is a block diagram illustrating an example embodiment of a wireless device. The wireless device is an example of the wireless devices 110 illustrated in FIG. 4. In particular embodiments, the wireless device is capable of obtaining capability information about a capability of the wireless device for performing simultaneous sidelink communication over multiple carriers of a radio band, and communicating the capability information to a network element (e.g., network node or another wireless device).

Particular examples of a wireless device include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, a vehicle-to-vehicle device, or any other device that can provide wireless communication. The wireless device includes processing circuitry 700. Processing circuitry 700 includes transceiver 710, processor 720, memory 730, and power source 740. In some embodiments, transceiver 710 facilitates transmitting wireless signals to and receiving wireless signals from wireless network node 120 (e.g., via an antenna), processor 720 executes instructions to provide some or all of the functionality described herein as provided by the wireless device, and memory 730 stores the instructions executed by processor 720. Power source 740 supplies electrical power to one or more of the components of wireless device 110, such as transceiver 710, processor 720, and/or memory 730.

Processor 720 includes any suitable combination of hardware and software implemented in one or more integrated circuits or modules to execute instructions and manipulate data to perform some or all of the described functions of the wireless device. In some embodiments, processor 720 may include, for example, one or more computers, one more programmable logic devices, one or more central processing units (CPUs), one or more microprocessors, one or more applications, and/or other logic, and/or any suitable combination of the preceding. Processor 720 may include analog and/or digital circuitry configured to perform some or all of the described functions of wireless device 110. For example, processor 720 may include resistors, capacitors, inductors, transistors, diodes, and/or any other suitable circuit components.

Memory 730 is generally operable to store computer executable code and data. Examples of memory 730 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

Power source 740 is generally operable to supply electrical power to the components of wireless device 110. Power source 740 may include any suitable type of battery, such as lithium-ion, lithium-air, lithium polymer, nickel cadmium, nickel metal hydride, or any other suitable type of battery for supplying power to a wireless device.

In particular embodiments, processor 720 in communication with transceiver 710 obtains capability information about a capability of the wireless device for performing simultaneous sidelink communication over multiple carriers of a radio band, and communicates the capability information to a network element (e.g., network node or another wireless device).

Other embodiments of the wireless device may include additional components (beyond those shown in FIG. 7A) responsible for providing certain aspects of the wireless device's functionality, including any of the functionality described above and/or any additional functionality (including any functionality necessary to support the solution described above).

FIG. 7B is a block diagram illustrating example components of a wireless device 110. The components may include determining module 750 and communicating module 752.

Determining module 750 may perform the determining and/or obtaining functions of wireless device 110. For example, determining module 750 may obtain capability information about a capability of wireless device 110 for performing simultaneous sidelink communication over multiple carriers of a radio band according to any of the examples or embodiments described above. In certain embodiments, determining module 750 may include or be included in processor 720. In particular embodiments, determining module 750 may communicate with communicating module 752.

Communicating module 752 may perform the communicating functions of wireless device 110. For example, communicating module 752 may communicate the capability information to network node 120 or another wireless device 110 according to any of the examples or embodiments described above. In certain embodiments, communicating module 752 may include or be included in processor 720. In particular embodiments, communicating module 752 may communicate with determining module 750.

FIG. 8A is a block diagram illustrating an example embodiment of a network node. The network node is an example of the network node 120 illustrated in FIG. 4. In particular embodiments, the network node is capable of receiving capability information about a capability of a wireless device for performing simultaneous sidelink communication over multiple carriers of a radio band, and scheduling a sidelink communication over one or more of the multiple carriers of the radio band.

Network node 120 can be an eNodeB, a nodeB, a base station, a wireless access point (e.g., a Wi-Fi access point), a low power node, a base transceiver station (BTS), a transmission point or node, a remote RF unit (RRU), a remote radio head (RRH), or other radio access node. The network node includes processing circuitry 800. Processing circuitry 800 includes at least one transceiver 810, at least one processor 820, at least one memory 830, and at least one network interface 840. Transceiver 810 facilitates transmitting wireless signals to and receiving wireless signals from a wireless device, such as wireless devices 110 (e.g., via an antenna); processor 820 executes instructions to provide some or all of the functionality described above as being provided by a network node 120; memory 830 stores the instructions executed by processor 820; and network interface 840 communicates signals to backend network components, such as a gateway, switch, router, Internet, Public Switched Telephone Network (PSTN), controller, and/or other network nodes 120. Processor 820 and memory 830 can be of the same types as described with respect to processor 720 and memory 730 of FIG. 7A above.

In some embodiments, network interface 840 is communicatively coupled to processor 820 and refers to any suitable device operable to receive input for network node 120, send output from network node 120, perform suitable processing of the input or output or both, communicate to other devices, or any combination of the preceding. Network interface 840 includes appropriate hardware (e.g., port, modem, network interface card, etc.) and software, including protocol conversion and data processing capabilities, to communicate through a network.

In particular embodiments, processor 820 in communication with transceiver 810 receives capability information about a capability of a wireless device for performing simultaneous sidelink communication over multiple carriers of a radio band, and schedules a sidelink communication over one or more of the multiple carriers of the radio band.

Other embodiments of network node 120 include additional components (beyond those shown in FIG. 8A) responsible for providing certain aspects of the network node's functionality, including any of the functionality described above and/or any additional functionality (including any functionality necessary to support the solution described above). The various different types of network nodes may include components having the same physical hardware but configured (e.g., via programming) to support different radio access technologies, or may represent partly or entirely different physical components.

FIG. 8B is a block diagram illustrating example components of a network node 120. The components may include communicating module 850 and load-balancing module 852.

Communicating module 850 may perform the communicating functions of network node 120. For example, communicating module 850 may receive capability information about a capability of wireless device 110 for performing sidelink communication over multiple carriers of a radio band according to any of the examples or embodiments described above. In certain embodiments, communicating module 850 may include or be included in processor 820. In particular embodiments, communicating module 850 may communicate with load-balancing module 852.

Load-balancing module 852 may perform the load-balancing and/or scheduling functions of network node 120. For example, load-balancing module 852 may schedule a communication (e.g., sidelink and/or Uu) over one or more of the multiple carriers of the radio band for one or more wireless devices 110 according to any of the examples or embodiments described above. In certain embodiments, load-balancing module 852 may include or be included in processor 820. In particular embodiments, load-balancing module 852 may communicate with communicating module 850.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the claims below.

Abbreviations used in the preceding description include:

3GPP Third Generation Partnership Project

ACK Acknowledgement

BLER Block Error Rate

BTS Base Transceiver Station

C-MTC Critical Machine Type Communication

CRC Cyclic Redundancy Check

D2D Device to Device

DL Downlink

DSRC Dedicated short-range communications

eNB eNodeB

FDD Frequency Division Duplex

FEC Forward Error-correction Code

HARQ Hybrid Automatic Repeat Request

ITS Intelligent Transport System

LTE Long Term Evolution

MAC Medium Access Control

M2M Machine to Machine

MIMO Multi-Input Multi-Output

MTC Machine Type Communication

NAK Negative Acknowledgement

NR New Radio

PDSCH Physical Downlink Shared Channel

ProSe Proximity Services

PUCCH Physical Uplink Control Channel

RAN Radio Access Network

RAT Radio Access Technology

RB Radio Bearer

RBS Radio Base Station

RNC Radio Network Controller

RRC Radio Resource Control

RRH Remote Radio Head

RRU Remote Radio Unit

SINR Signal-to-Interference-plus-Noise Ratio

TDD Time Division Duplex

UE User Equipment

UL Uplink

UTRAN Universal Terrestrial Radio Access Network

V2X Vehicle-to-Everything

V2V Vehicle-to-Vehicle

V2P Vehicle-to-Pedestrian

V2I Vehicle-to-Infrastructure

WAN Wireless Access Network

1. A method for use in a wireless device of signalling capability information, the method comprising:
obtaining capability information about a capability of the wireless device for performing simultaneous sidelink communication over multiple carriers of a radio band; and
communicating the capability information to a network element.

2. The method of claim 1, wherein the capability information comprises a capability of the wireless device for simultaneously transmitting sidelink communication over multiple carriers of the radio band.

3. The method of claim 1, wherein the capability information comprises a capability of the wireless device for simultaneously receiving sidelink communication over multiple carriers of the radio band.

4. The method of claim 1, wherein the capability information comprises a capability of the wireless device for simultaneously performing sidelink communication and non-sidelink communication over multiple carriers of the radio band.

5. The method of claim 4, wherein the non-sidelink communication comprises Uu communication.

6. The method of claim 1, wherein the capability information comprises an indication of whether the wireless device uses sidelink gaps for multicarrier communication.

7. The method of claim 1, wherein the radio band comprises an unlicensed band.

8. The method of claim 1, wherein the network element comprises a network node.

9. The method of claim 1, wherein the network element comprises a wireless device.

10. The method of claim 1, wherein the sidelink communication comprises a V2x communication.

11. A method for use in a network node of scheduling communication, the method comprising:
receiving capability information about a capability of a wireless device for performing simultaneous sidelink communication over multiple carriers of a radio band; and
scheduling a communication over one or more of the multiple carriers of the radio band for one or more wireless devices.

12. The method of claim 11, wherein scheduling the communication comprises scheduling at least one of a sidelink communication and a Uu communication.

13. The method of claim 11, wherein scheduling the communication comprises scheduling a traffic safety message over two or more of the multiple carriers.

14. The method of claim 11, wherein the capability information comprises a capability of the wireless device for simultaneously transmitting sidelink communication over multiple carriers of the radio band.

15. The method of claim 11, wherein the capability information comprises a capability of the wireless device for simultaneously receiving sidelink communication over multiple carriers of the radio band.

16. The method of claim 11, wherein the capability information comprises a capability of the wireless device for simultaneously performing sidelink communication and non-sidelink communication over multiple carriers of the radio band.

17. The method of claim 16, wherein the non-sidelink communication comprises Uu communication.

18. The method of claim 11, wherein the capability information comprises an indication of whether the wireless device uses sidelink gaps for multicarrier communication.

19. The method of claim 11, wherein the radio band comprises an unlicensed band.

20. A wireless device operable to signal capability information, the wireless device comprising processing circuitry and a transceiver:
the processing circuitry operable to obtain capability information about a capability of the wireless device for performing simultaneous sidelink communication over multiple carriers of a radio band; and
the transceiver operable to communicate the capability information to a network element.

21. The wireless device of claim 20, wherein the capability information comprises a capability of the wireless device for simultaneously transmitting sidelink communication over multiple carriers of the radio band.

22. The wireless device of claim 20, wherein the capability information comprises a capability of the wireless device for simultaneously receiving sidelink communication over multiple carriers of the radio band.

23. The wireless device of claim 20, wherein the capability information comprises a capability of the wireless device for simultaneously performing sidelink communication and non-sidelink communication over multiple carriers of the radio band.

24. The wireless device of claim 23, wherein the non-sidelink communication comprises Uu communication.

25. The wireless device of claim 20, wherein the capability information comprises an indication of whether the wireless device uses sidelink gaps for multicarrier communication.

26. The wireless device of claim 20, wherein the radio band comprises an unlicensed band.

27. The wireless device of claim 20, wherein the network element comprises a network node.

28. The wireless device of claim 20 wherein the network element comprises a wireless device.

29. The wireless device of claim 20, wherein the sidelink communication comprises a V2x communication.

30. A network node operable to schedule communication, the network node comprising processing circuitry and a transceiver:
the transceiver operable to receive capability information about a capability of a wireless device for performing simultaneous sidelink communication over multiple carriers of a radio band; and
the processing circuitry operable to schedule a communication over one or more of the multiple carriers of the radio band for one or more wireless devices.

31. The network node of claim 30, wherein the processing circuitry is operable to schedule at least one of a sidelink communication and a Uu communication.

32. The network node of claim 30, wherein the processing circuitry is operable to schedule a traffic safety message over two or more of the multiple carriers.

33. The network node of claim 30, wherein the capability information comprises a capability of the wireless device for simultaneously transmitting sidelink communication over multiple carriers of the radio band.

34. The network node of claim 30, wherein the capability information comprises a capability of the wireless device for simultaneously receiving sidelink communication over multiple carriers of the radio band.

35. The network node of claim 30, wherein the capability information comprises a capability of the wireless device for simultaneously performing sidelink communication and non-sidelink communication over multiple carriers of the radio band.

36. The network node of claim 35, wherein the non-sidelink communication comprises Uu communication.

37. The network node of claim 30, wherein the capability information comprises an indication of whether the wireless device uses sidelink gaps for multicarrier communication.

38. The network node of claim 30, wherein the radio band comprises an unlicensed band.

39. (canceled)

40. (canceled)
